(19) United States
(12) Patent Application Publication
(10) Pub. No.: US 2005/0130040 A1
(43) Pub. Date: Jun. 16, 2005

(54) Negative electrode for rechargeable lithium battery and rechargeable lithium battery comprising same

(76) Inventors: Ho-Jung Yang, Suwon-si (KR); Sang-Moon Hwang, Suwon-si (KR)

Correspondence Address: CHRISTIE, PARKER & HALE, LLP, PO BOX 7068, PASADENA, CA, 91109-7068, US

(21) Appl. No.: 10/990,149

(22) Filed: Nov. 15, 2004

(30) Foreign Application Priority Data
Nov. 17, 2003 (KR) 10-2003-0081042

(51) Int. Cl. H01M 4/62; H01M 4/58; H01M 4/40

(52) U.S. Cl. 429/217; 429/231.8; 429/231.4; 429/231.95; 429/232

(57) ABSTRACT

The present invention relates to an electrode for a rechargeable lithium battery comprising an emulsion binder, and a lithium secondary battery including the same. The electrode comprises a current collector coated with an active material layer including active material powder, a polyolefinic polymer, and a water-soluble polymer. The polyolefinic polymer binder has better binding properties than a conventional polyvinylidene fluoride, and sufficient adhesion can be realized using a small amount. A decrease in the amount of the binder, which is non-conductive, improves charge-discharge capacity and cycle life characteristics. The polyolefinic polymer has a good crystallization degree and reduces electrode expandability resulting in improved cycle-life characteristics for the electrode.

### CROSS REFERENCE TO RELATED APPLICATION

This application claims priority to and the benefit of Korean Application No. 10-2003-0081042 filed in the Korean Patent Office on Nov. 17, 2003, the disclosure of which is incorporated hereinto by reference.

### FIELD OF THE INVENTION

The present invention relates to an electrode for a rechargeable lithium battery, and a lithium secondary battery including the same, and more particularly, to an electrode for a rechargeable lithium battery having good adhesion force and being capable of improving the capacity and cycle life characteristics of a rechargeable lithium battery and a lithium secondary battery including the same.

### BACKGROUND OF THE INVENTION

Recently, carbonaceous materials that do not generate lithium dendrites have been introduced for use in place of lithium metal as the negative active material for rechargeable lithium batteries. A negative electrode is produced by mixing a negative active material and a binder, and optionally a conductive material in an organic solvent to prepare a negative active material composition, and coating the composition on a current collector followed by drying.

The binder provides adhesion between the current collector and active material powders and adhesion among the active material powders when coating the active material on the current collector. In addition to good adhesion properties, desired features for the binder include good electrochemical stability, non-flammability, electrolyte-wettability, low electrode expandability, and high dispersion and crystallization degrees.

Polyvinylidene fluoride is generally used as a binder. However, polyvinylidene fluoride is a fiber which tends to cover the negative active material, making it difficult for the active material to effectively perform its function. Furthermore, polyvinylidene fluoride binder has somewhat insufficient adhesion which results in the separation of the negative active material from the current collector as charge and discharge cycles are repeated, thereby decreasing capacity and deteriorating the cycle life characteristics.

Furthermore, while N-methyl-2-pyrrolidone organic solvent is a good solvent for polyvinylidene fluoride, it tends to generate a vapor that can cause safety problems.

A binder that is suitable for an active material developed for high performance is desired. A carbonaceous material as a negative material is a chemically inactive material, but the structure and surface properties (hydrophobic or hydrophilic) of the negative material vary depending on the kind of active material and thus satisfactory adhesion is difficult to obtain. In particular, a natural graphite-based active material has a flat shape and thus its tap density and appearance density are very low resulting in deterioration of adhesion when a PVdF binder is used in a conventional amount.

Investigation into the use of styrene butadiene rubber (SBR) and polytetrafluoroethylene as binders have been undertaken. Such materials do not cause the negative active material to be covered, and they can be used in aqueous solutions such that solvent removal is not necessary. However, these materials exhibit poor adhesion compared to polyvinylidene fluoride, and do not exhibit good cycle life characteristics. In addition, SBR exhibits high expandability and tends to agglomerate in a slurry resulting in poor dispersion.

### SUMMARY OF THE INVENTION

In one embodiment of the present invention an electrode is provided for a lithium secondary battery in which superior adhesion of negative active material and improved capacity and cycle life characteristics are realized.

In another embodiment of the present invention, a lithium secondary battery is provided exhibiting good capacity and cycle life characteristics.

In yet another embodiment of the present invention, an electrode for a lithium secondary battery includes a current collector, and an active material layer formed on the current collector. The active material layer includes an active material, a polyolefin-based polymer and a water-soluble polymer.

In still another embodiment of the present invention, a lithium secondary battery is provided that includes the electrode.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawing, wherein:

FIG. 1 is an exploded perspective view showing a rechargeable lithium battery according to one embodiment of the present invention.

### DETAILED DESCRIPTION OF THE INVENTION

In one embodiment of the present invention, in order to achieve good adhesion of the electrode for a rechargeable lithium battery, a polyolefin-based emulsion is used as a binder material.

According to one embodiment of the invention, the electrode comprises an active material layer including active material powders, a polyolefinic polymer, and a water-soluble polymer on a current collector.

The binder has better adhesion than a conventional polyvinylidene fluoride binder, which reduces the amount of binder necessary. This allows an increase in the amount of active material which increases charge and discharge capacity, and a reduction of the amount of the non-conductive material, i.e. binder, which decreases the impedance, thereby improving the high-rate characteristics. The electrode has a good crystallization degree and reduces electrode expandability resulting in improved cycle-life characteristics.

Examples of the polyolefin-based polymer include polyethylene, polypropylene, and mixtures thereof.

In one embodiment, the amount of the binder is 0.1 to 10, and preferably 0.1 to 8 parts by weight based on 100 parts by weight of the negative active material. If the amount of the binder is less than 0.1 parts by weight, sufficient adhesion between the active material and the collector cannot be obtained. If the amount of the binder is more than 10 parts by weight, capacity characteristics deteriorate.

The water-soluble polymer may be carboxymethylcellulose (CMC), polyvinyl alcohol, polyvinylpyrrolidone, polyacrylic acid, polymethacrylic acid, polyethylene oxide, polyacrylamide, poly-N-isopropyleacrylamide, poly-N,N-dimethylacrylamide, polyethyleneimine, polyoxyethylene, poly(2-methoxyethoxyethylene), poly(3-morpyrinylethylene), polyvinylsulfonic acid, polyvinylidene fluoride, amylase, or mixtures thereof. One preferred water-soluble polymer is CMC. The use of CMC increases viscosity, allows uniform coating, and provides good adhesion which helps prevent the separation of the active material from the collector and provides good cycle life characteristics.

In one embodiment, the amount of the water-soluble polymer is 0.1 to 10, and preferably 0.1 to 8 parts by weight based on 100 parts by weight of the negative active material. If the amount of the water-soluble polymer is less than 0.1 parts by weight, the viscosity of the coating composition decreases, causing uneven coating, and separation of the active material from the collector occurs, decreasing capacity. If the amount of the water-soluble polymer is more than 10 parts by weight, the impedance increases and battery performance and flexibility deteriorate.

The water-soluble polymer acts as a thickener. When it is used in an amount within the above range, detachment of the active material can be prevented and without deteriorating battery performance.

The negative active material and the current collector include any materials which are conventionally used, and are not limited to the examples set forth herein.

The negative active material may include a material that is capable of reversible intercalation/deintercalation of the lithium ions. Examples of negative active material are carbonaceous materials such as artificial graphite, natural graphite, graphitized carbon fiber, graphitized mesocarbon microbeads, fullerene, and amorphous carbon. In one embodiment, the carbonaceous material has a d002 interplanar distance of 3.35-3.38 Å, an Lc (crystallite size) measured by X-ray diffraction of more than 20 nm, and an exothermic peak of at least 700° C.

The negative active material may also include a metal which is capable of alloying with lithium, and a mixed material of the carbonaceous material and the metal. Examples of metals which are capable of alloying with lithium include Al, Si, Sn, Pb, Zn, Bi, In, Mg, Ga, Cd, Ge, and similar metals. The current collector may also include a punching metal, an exmet punching metal, a metal foil, a foamed metal, a mesh metal-fiber calcinated body or the like. Examples of metal foils include nickel foil and copper foil.

The negative electrode may also comprise a conductive agent. Examples of conductive agents include nickel powder, cobalt oxide, titanium oxide, and carbon. Examples of suitable carbon materials include ketjen black, acetylene black, furnace black, denka black, graphite, carbon fiber, fullerene, and similar materials.

In one embodiment, a rechargeable lithium battery includes the negative electrode described above. The negative electrode exhibits good adhesion between the active materials and the current collector and among the active material powders, and prevents the detachment of the active materials from the electrode even where there is a change in volume of the active material powders during charging and discharging. This results in improved cycle life characteristics. Because the binder is a non-conductive material and less binder is used according to the present invention, electrode impedance can also be reduced resulting in improved current characteristics at a high rate.

A negative electrode of the present invention may be fabricated by preparing a slurry in water of active material powders, a polyolefinic polymer in an emulsion state, and a water-soluble polymer. The slurry is coated onto a metal current collector, dried and compressed. The negative electrode is generally provided as a sheet, but may also be cylindrical, disk-shaped, flat, or rod-shaped.

In an embodiment of the present invention, the aqueous binder and aqueous thickener dispersed in the aqueous dispersion do not require special facilities for handling organic solvents which are required for conventional binders. This results in cost reductions and reduces the possibility of environmental contamination.

In another embodiment of the present invention, a rechargeable lithium battery is provided including the negative electrode. The rechargeable lithium battery includes a positive electrode, a negative electrode, and an electrolyte, and optionally a separator.

In general, any positive electrode may be used. For example, the positive electrode can be fabricated by mixing a positive active material powder, polyvinylidene fluoride as a binder, and carbon black as a conductive agent to obtain a paste. The paste is coated and formed into a shape such as a flat sheet.

Examples of positive active material include LiMn₂O₄, LiCoO₂, LiNiO₂, LiFeO₂, V₂O₅, and similar materials. An active material capable of intercalating/deintercalating lithium ions, such as TiS, MoS, organic disulfide, organic polysulfide or similar materials may be used. As the conductive agent, ketjen black, acetylene black, furnace black, denka black, graphite, carbon fiber, or fullerene can be used. As the binder, it is possible to use a water-soluble polymer such as carboxymethylcellulose methylcellulose or sodium polyacrylate, as well as polyvinylidene fluoride.

A positive electrode is fabricated by mixing a positive active material, a binder, and a conductive agent, then coating the mixture on a current collector such as a metal foil or metal net, drying it, and compressing it into a sheet shape.

A separator may be made from any material which is generally used for separators for rechargeable lithium batteries. For example, the separator may be made from polyethylene, polypropylene, polyvinylidene fluoride, polyamide, glass fiber or similar materials, or a multilayered structure may be used.

A non-aqueous electrolyte of the present invention may further include a non-aqueous organic solvent and a lithium salt.

Examples of the non-aqueous organic solvent include propylene carbonate, ethylene carbonate, butylene carbonate, benzonitrile, acetonitrile, tetrahydrofuran, 2-methyl tetrahydrofuran, γ-butyrolactone, dioxolane, 4-methyl dioxolane, N,N-dimethylformamide, dimethylacetoamide, dimethylsulfoxide, dioxan, 1,2-dimethoxyethane, sulfolane, dichloroethane, chlorobenzene, nitrobenzene, dimethylcarbonate, methylethylcarbonate, diethylcarbonate, methylpropylcarbonate, methylisopropylcarbonate, ethylbutyl carbonate, dipropyl carbonate, diisopropyl carbonate, dibutylcarbonate, diethyleneglycol, dimethylether, and mixtures thereof, but are not limited thereto. Any solvent which has been used for a rechargeable lithium battery can be made available. In one particular embodiment, a mixture of at least one of propylene carbonate, ethylene carbonate, and butylene carbonate and at least one of dimethyl carbonate, methylethyl carbonate, and diethylcarbonate are preferred.

The lithium salt may be at least one salt selected from LiPF₆, LiBF₄, LiAsF₆, LiCF₃SO₃, LiN(CF₃SO₂)₃, Li(CF₃SO₂)₂N, LiC₄F₉SO₃, LiClO₄, CF₃SO₃Li, LiN(SO₂C₂F₅)₂, LiSbF₆, LiAlO₄, LiAlCl₄, LiN(CₓF₂ₓ₊₁SO₂)(CₓF_{2y+1}SO₂) (where x and y are natural numbers), LiCl, or LiI. Preferred salts are LiPF₆, LiBF4, or mixtures thereof.

The concentration of the lithium salt preferably ranges from 0.6 to 2.0 M, and more preferably from 0.7 to 1.6 M. When the concentration of the lithium salt is less than 0.6 M, the electrolyte performance deteriorates due to its ionic conductivity. When the concentration of the lithium salt is greater than 2.0 M, the lithium ion mobility decreases due to an increase of the electrolyte viscosity. The lithium salt of a battery provides a source of lithium ions, making the basic operation of a lithium secondary battery possible.

The electrolyte may also be a polymer electrolyte which comprises a polymer having good expandability with respect to an electrolyte solution. Examples include polyethylene oxide, polypropylene oxide, polyacetonitrile, polyvinylidene fluoride, polymethacrylate, polymethylmethacrylate, and similar polymers.

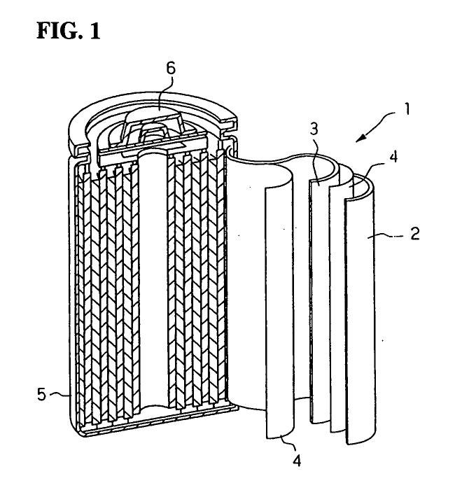

A rechargeable lithium battery of the present invention is generally fabricated by putting a positive electrode, a negative electrode, an electrolyte, and optionally, a separator, into a case, and sealing it. As shown in FIG. 1, a cylindrical rechargeable lithium battery includes a negative electrode 2 according to the present invention, a sheet type positive electrode 3, a separator 4 interposed between the negative electrode 2 and the positive electrode 3, electrolyte into which the negative electrode 2, the positive electrode 3 and the separator 4 are immersed, a cylindrical battery case 5, and a sealing member 6 for sealing the battery case 5. The rechargeable lithium battery 1 is manufactured by spirally winding the negative electrode 2, the positive electrode 3, and the separator 4 to produce an electrode element, and inserting the electrode element into the battery case 5.

The rechargeable lithium battery including the negative electrode comprising the aforementioned structure has good cycle life characteristics due to the good attachment between the current collector and the active material powders during charge and discharge.

The present invention is further explained in more detail with reference to the following examples. These examples, however, should not be interpreted as limiting the scope of the present invention in any manner.

### EXAMPLE 1

After mixing 95 parts by weight of artificial graphite as a negative active material with 2.5 parts by weight of polyethylene emulsion and 2.5 parts by weight of carboxy methylcellulose (CMC), a negative slurry was prepared by dispersing the mixture in 200 parts by weight of pure water. The slurry was coated on copper foil, dried, and compressed with a roll press, thereby manufacturing a negative electrode with an active mass density of 1.5 g/cc.

After mixing 90 parts by weight of LiCoO₂ as a positive active material, 5 parts by weight of polyvinylidenefluoride (PVdF) as a binder, and 5 parts by weight of Super-P as a conductive agent, a positive slurry was prepared by dispersing the mixture into 100 parts by weight of N-methyl-2-pyrrolidone. The slurry was coated on aluminum foil, dried, and compressed with a roll press, thereby manufacturing a positive electrode with an active mass density of 3.0 g/cc.

Together with a polyethylene separator, the manufactured negative and positive electrodes were wound and pressed, then placed into a battery case. An electrolyte including 1.0M LiPF₆ dissolved in a mixed solvent of ethylene carbonate/dimethyl carbonate/ethylmethyl carbonate (at a volume ratio of 3/3/4) was added thereto, thereby completing the manufacture of the battery cell.

### EXAMPLE 2

After mixing 98 parts by weight of artificial graphite as a negative active material with 1 part by weight of polyethylene emulsion and 1 part by weight of carboxy methylcellulose (CMC), a negative slurry was prepared by dispersing the mixture in 200 parts by weight of pure water. The slurry was coated on copper foil, dried, and compressed with a roll press, thereby manufacturing a negative electrode with an active mass density of 1.5 g/cc. Using the negative electrode, a lithium battery cell was manufactured in the same manner as in Example 1.

### EXAMPLE 3

After mixing 95 parts by weight of natural graphite as a negative active material with 2.5 parts by weight of polyethylene emulsion and 2.5 parts by weight of carboxy methylcellulose (CMC), a negative slurry was prepared by dispersing the mixture in 200 parts by weight of pure water. The slurry was coated on copper foil, dried, and compressed with a roll press, thereby manufacturing a negative electrode with an active mass density of 1.5 g/cc. Using the negative electrode, a lithium battery cell was manufactured in the same manner as in Example 1.

### COMPARATIVE EXAMPLE 1

After mixing 97 parts by weight of artificial graphite as a negative active material with 3 parts by weight of polyvinylidene fluoride, a negative slurry was prepared by dispersing the mixture in 100 parts by weight of NMP. The slurry was coated on copper foil, dried, and compressed with a roll press, thereby manufacturing a negative electrode with an active mass density of 1.5 g/cc. Using the negative electrode, a lithium battery cell was manufactured in the same manner as in Example 1.

### COMPARATIVE EXAMPLE 2

After mixing 98 parts by weight of artificial graphite as a negative active material with 1 part by weight of styrene butadiene rubber and 1 part by weight of CMC, a negative slurry was prepared by dispersing the mixture in 180 parts by weight of pure water. The slurry was coated on copper foil, dried, and compressed with a roll press, thereby manufacturing a negative electrode with an active mass density of 1.5 g/cc. Using the negative electrode, a lithium battery cell was manufactured in the same manner as in Example 1.

### COMPARATIVE EXAMPLE 3

After mixing 95 parts by weight of modified natural graphite as a negative active material with 2.5 parts by weight of styrene butadiene rubber and 2.5 parts by weight of CMC, a negative slurry was prepared by dispersing the mixture in 200 parts by weight of pure water. The slurry was coated on copper foil, dried, and compressed with a roll press, thereby manufacturing a negative electrode with an active mass density of 1.5 g/cc. Using the negative electrode, a lithium battery cell was manufactured in the same manner as in Example 1.

In order to evaluate adhesion between the active mass and the copper foil of each of the negative electrodes of Examples 1 to 3 and Comparative Examples 1 to 3, peel strength was measured. The results are shown in Table 1. The peel strength was measured by attaching a 2.5 cm×3 cm piece of SCOTCH brand tape (3M Company) to each negative electrode. The force was then measured when detaching the tape from the negative electrode at an angle of 90 degrees and at a speed of 10 cm/min at room temperature.

The cycle life characteristics of Examples 1 to 3 and Comparative Examples 1 to 3 were also measured. The results are also shown in Table 1. The battery cells were charged at 800 mA, 4.2V under constant current and constant voltage for 2.5 hours, and then discharged at 800 mA to the cut-off voltage of 2.75V under a constant current. The charge and discharge was repeated 100 times to evaluate capacity decrease with charge-discharge cycles.

TABLE 1

| | Peel strength (g/mm) | Cycle life (%, 100^{th} cycle) |
|---|---|---|
| Example 1 | 2.0 | 94 |
| Example 2 | 1.2 | 93 |
| Example 3 | 1.9 | 92 |
| Comp. Example 1 | 1.0 | 60 |
| Comp. Example 2 | 0.5 | 89 |
| Comp. Example 3 | 1.0 | 88 |

As shown in Table 1, the negative electrodes of Examples 1 to 3 have good adhesion and provide good cycle life characteristics. Sufficient adhesion can be obtained although the polyolefinic polymer is used in a small amount as a binder, and therefore the amount of the binder can be decreased resulting in an increase of battery capacity.

The polyolefinic polymer binder has better binding properties than conventional polyvinylidene fluoride, and sufficient adhesion can be realized with a small amount of binder. A decrease of the amount of the binder which is non-conductive improves charge-discharge capacity by increasing the amount of the active material and more easily enables intercalation/deintercalation at a high rate of 1 C resulting in improved cycle life characteristics. The polyolefinic polymer has a good crystallization degree and also reduces electrode expandability resulting in improvement of cycle-life characteristics.

While the present invention has been described in detail with reference to the preferred embodiments, those skilled in the art will appreciate that various modifications and substitutions can be made thereto without departing from the spirit and scope of the present invention as set forth in the appended claims.

1. An electrode for a rechargeable lithium battery, comprising:
a current collector; and
an active material layer coating the current collector, the active material layer comprising active material, a polyolefinic polymer, and a water-soluble polymer.

2. The electrode of claim 1, wherein the polyolefinic polymer is selected from the group consisting of polyethylene, polypropylene, and combinations thereof.

3. The electrode of claim 1, wherein the polyolefinic polymer is provided in an amount from 0.1 to 10 parts by weight based on 100 parts by weight of the active material layer.

4. The electrode of claim 1, wherein the water-soluble polymer is selected from the group consisting of carboxymethylcellulose (CMC), polyvinyl alcohol, polyvinylpyrrolidone, polyacrylic acid, polymethacrylic acid, polyethylene oxide, polyacrylamide, poly-N-isopropyleacrylamide, poly-N,N-dimethylacrylamide, polyethyleneimine, polyoxyethylene, poly(2-methoxyethoxyethylene), poly(3-morpyrinylethylene), polyvinylsulfonic acid, polyvinylidene fluoride, amylase, and combinations thereof.

5. The electrode of claim 1, wherein the water-soluble polymer is provided in an amount from 0.1 to 10 parts by weight based on 100 parts by weight of the active material layer.

6. The electrode of claim 1, wherein the active material is selected from the group consisting of materials capable of reversible intercalation/deintercalation of lithium ions, metals capable of alloying with lithium, and combinations thereof.

7. The electrode of claim 6, wherein the active material is a material capable of reversible intercalation/deintercalation of lithium ions selected from the group consisting of artificial graphite, natural graphite, graphitized carbon fiber, graphitized mesocarbon microbeads, fullerene, amorphous carbon, and combinations thereof.

8. The electrode of claim 6, wherein the active material is a metal capable of alloying with lithium selected from the group consisting of Al, Si, Sn, Pb, Zn, Bi, In, Mg, Ga, Cd, Ge, and combinations thereof.

9. The electrode of claim 1, wherein the current collector is selected from the group consisting of punching metals, exmet punching metals, metal foils, foamed metals, and mesh metal-fiber calcinated bodies.

10. The electrode of claim 1, wherein the active material layer further comprises a conductive agent.

11. The electrode of claim 10, wherein the conductive agent is selected from the group consisting of nickel powder, cobalt oxide, titanium oxide, carbon, and combinations thereof.

12. The electrode of claim 11, wherein the conductive agent comprises carbon selected from the group consisting of ketjen black, acetylene black, furnace black, denka black, graphite, carbon fiber, fullerene, and combinations thereof.

13. A rechargeable lithium battery comprising
a negative electrode comprising a current collector coated with an active material layer comprising negative active material, a polyolefinic polymer, and a water-soluble polymer;
a positive electrode; and
an electrolyte.

14. The rechargeable lithium battery of claim 13, wherein the polyolefinic polymer is selected from the group consisting of polyethylene, polypropylene, and combinations thereof.

15. The rechargeable lithium battery of claim 13, wherein the polyolefinic polymer is provided an amount from 0.1 to 10 parts by weight based on 100 parts by weight of the negative active material.

16. The rechargeable lithium battery of claim 13, wherein the water-soluble polymer is selected from the group consisting of carboxymethylcellulose (CMC), polyvinyl alcohol, polyvinylpyrrolidone, polyacrylic acid, polymethacrylic acid, polyethylene oxide, polyacrylamide, poly-N-isopropyleacrylamide, poly-N,N-dimethylacrylamide, polyethyleneimine, polyoxyethylene, poly(2-methoxyethoxyethylene), poly(3-morpyrinylethylene), polyvinylsulfonic acid, polyvinylidene fluoride, amylase, and combinations thereof.

17. The rechargeable lithium battery of claim 13, wherein the water-soluble polymer is provided in an amount from 0.1 to 10 parts by weight based on 100 parts by weight of the negative active material.

18. The rechargeable lithium battery of claim 13, wherein the negative active material is selected from the group consisting of materials capable of reversible intercalation/deintercalation of lithium ions, metals capable of alloying with lithium, and combinations thereof.

19. The rechargeable lithium battery of claim 18, wherein the negative active material is a material capable of reversible intercalation/deintercalation of lithium ions selected from the group consisting of artificial graphite, natural graphite, graphitized carbon fiber, graphitized mesocarbon microbeads, fullerene, amorphous carbon, and combinations thereof.

20. The rechargeable lithium battery of claim 18, wherein the negative active material comprises a metal capable of alloying with lithium selected from the group consisting of Al, Si, Sn, Pb, Zn, Bi, In, Mg, Ga, Cd, Ge, and combinations thereof.

21. The rechargeable lithium battery of claim 13, wherein the current collector is selected from the group consisting of punching metals, exmet punching metals, metal foils, foamed metals, and mesh metal-fiber calcinated bodies.

22. The rechargeable lithium battery of claim 13, wherein the negative electrode further comprises a conductive agent.

23. The rechargeable lithium battery of claim 22, wherein the conductive agent is selected from the group consisting of nickel powder, cobalt oxide, titanium oxide, carbon, and combinations thereof.

24. The rechargeable lithium battery of claim 23, wherein the conductive agent comprises carbon selected from the group consisting of ketjen black, acetylene black, furnace black, denka black, graphite, carbon fiber, fullerene, and combinations thereof.
